(19) United States
(12) Patent Application Publication
(10) Pub. No.: US 2026/0278638 A1
(43) Pub. Date: Sep. 17, 2026

(54) SYSTEMS AND METHODS FOR ANALYZING ADVERTISING MESSAGING

(71) Applicant: BRAZE, INC., New York, NY (US)

(72) Inventors: Matthew WILLETT-JEFFRIES, New York, NY (US); Amrit GILL, New York, NY (US); Robert UHRLASS, New York, NY (US)

(21) Appl. No.: 19/674,961

(22) Filed: May 12, 2026

Related U.S. Application Data
(63) Continuation of application No. 18/747,578, filed on Jun. 19, 2024, now abandoned.

(51) Int. Cl. G06Q 30/0242

(52) U.S. Cl. CPC G06Q 30/0242

(57) ABSTRACT

Systems and methods for predicting which of two alternate messages is likely to be more successful in motivating members of a target audience to take a particular type of action utilize a neural network to make such a prediction. The neural network can take into account information about the target audience in making the prediction. Such systems may also provide marketing personnel with an editing capability that allows a user to selectively edit marketing messages and to then receive immediate feedback about how the edits impact the likelihood that a message will motivate a member of a target audience to take a particular type of action.

This application is a continuation of U.S. Application No. 18/747,578, which was filed on June 19, 2024, the contents of which are incorporated herein by reference.

### BACKGROUND OF THE INVENTION

The invention is related to systems and methods for enhancing customer engagement. In part, this is accomplished by causing messages to be displayed to users, often on the users’ computing devices. The messages or information could be presented within a company’s software application that is running on a user’s computing device. Alternatively, the messages or information could be presented to the user as part of a company’s website that is being presented to the user by a web browser on the user’s computing device. In other instances, the messages could be delivered via various communications channels as email messages, SMS or text messages, voicemail recordings or via a live telephone call.

Companies often hire a customer engagement service – also called a customer relationship management service - to help manage the delivery of information and messages to their customers or users. The customer engagement service can help control the flow and timing of information and messages sent to a company’s customers to provide the customers with an enjoyable and informative experience. For example, some customers that are highly engaged with a company may wish to receive information or messages from the company on a frequent basis. Conversely, customers that are not highly engaged with the company may find frequent messages from the company annoying and undesirable. The customer engagement service can help determine what individual customers desire, and then manage the flow of information and messaging to customers based on their individual desires.

The customer engagement service can also cause information and messages to be delivered to customers at opportune times when the information or messaging may have the most influence over customer behavior. Similarly, the customer engagement service may know when certain types of information or messages will have the greatest value to customers, and then seek to deliver those types of information or messages at those times.

The present application describes systems and methods that help marketing personnel decide exactly what messages to send to a target audience of users. Ideally, a marketing message sent to a target audience will be engaging for the target audience, causing members of the target audience viewing the message to take a certain action, such as purchasing a certain product. Some messages are more engaging than others. Thus, marketers attempt to design marketing messages to be as engaging as possible.

One technique that marketers use to help decide on the content and format of a message is to conduct “A/B testing”. This involves generating first and second messages that are both designed to accomplish essentially the same thing or to deliver essentially the same information or marketing message. The first message is sent to a first small audience and the second message is sent to a second small audience. The marketers then determine which of the two messages was the most successful based on how the audience members reacted to the first and second messages. The most successful version of the message is then sent to a larger audience.

Unfortunately, there are multiple drawbacks to conducting A/B testing. One drawback is that it can take a considerable amount of time to determine which of the two alternative messages is the most successful. In some instances, it can take weeks or months to determine which of two alternate messages is likely to be the most successful with the target audience.

Another problem is that effectively accomplishing A/B testing requires a fairly large audience. When conducting A/B testing, you must use portions of the total audience to conduct the testing, after which the most successful message is sent to the remainder of the audience. If the overall audience is small to begin with, the A/B testing process becomes impractical and less effective. In other words, if the overall audience for a highly specific marketing message is small to begin with, and a significant portion of that small audience is part of the A/B testing, the most successful marketing message is only shown to a relatively small number of individuals.

Because of the widespread adoption of the Internet and the way in which electronic messaging is now delivered, it is increasingly possible for marketers to acquire information about the preferences and characteristics of specific individuals, even when the actual identity of those individuals remains confidential and unknown to the marketers. As a result, marketers are able to divide up a large potential audience into small subsections that share common interests. The marketers can then send a highly specific marketing message to a small subset of the total potential audience, where the message is designed to appeal to that small subset.

The ability to target a specific message to a small audience that is likely to find the message appealing is generally a good thing. But it makes it difficult to conduct A/B testing because the overall audience for a particular message is relatively small. Thus, the ability to target marketing messages to smaller and smaller target audiences has also had the effect of making A/B testing of such marketing messages less worthwhile.

In addition, the feedback received from A/B testing tends to relate only to the specific alternate messages that were sent. This is particularly true when the messages have been carefully tailored to appeal to members of a small target audience. It can be difficult to extrapolate whether a slightly altered version of the most successful of the two original messages will still be deemed more successful than the less successful of the two original messages.

Moreover, in the past marketers, could use A/B testing to learn what tone, vocabulary or style seems most effective for marketing messages. But the knowledge gained when conducting A/B testing for a small target audience that shares common interests often cannot be reused or relied upon for similar marketing messages that will be directed to a different small target audience having different shared common interests. This is another reason why A/B testing is becoming less useful or effective as marketers are able to target increasingly small subsets of a total audience based on the interests and characteristics of the individual members of the target audience.

### BRIEF DESCRIPTION OF THE DRAWINGS

FIG. 1 is a diagram of a communications environment which could be utilized by systems and methods embodying the invention;

FIG. 2 is a diagram of selected elements of a customer engagement service;

FIG. 3 is a diagram illustrating selected elements of a message prediction system;

FIG. 4 is a flowchart illustrating steps of a first method of generating a prediction about which of two alternate messages is likely to be more successful with a target audience;

FIG. 5 is a flowchart illustrating steps of a second method of generating a prediction about which of two alternate messages is likely to be more successful with a target audience;

FIG. 6 is a flowchart illustrating steps of a method of editing and iteratively testing two alternate messages to determine which of the two messages is likely to be more successful with a target audience; and

FIG. 7 is a diagram of a computer system and associated peripherals which could embody the invention, or which could be used to practice methods embodying the invention.

### DETAILED DESCRIPTION OF PREFERRED EMBODIMENTS

The following detailed description of preferred embodiments refers to the accompanying drawings, which illustrate specific embodiments of the invention. Other embodiments having different structures and operations do not depart from the scope of the present invention.

Systems and methods embodying the invention can be part of a customer engagement service. As mentioned above, a customer engagement service helps a company interact with its users to enhance the customer experience and to increase the company’s business, revenue and/or stature. One of the ways that a customer engagement service assists a company is by helping the company to manage how and when messages are delivered to the company’s customers, and the content and form of those messages.

One way that the customer engagement service assists a company is by helping the company to create messages that are highly effective. This can include conducting testing of alternate forms of a message to predict which of the alternate forms of the message are likely to be more successful in causing a user viewing the message to take a particular type of action.

The following description refers to “clients” or “companies” and to “users”. For purposes of this discussion, a “client” or a “company” would be a client of the customer engagement service. In other words, a client or a company is a business that is being assisted by the customer engagement service. “Users” are a client’s or company’s users, not users of the customer engagement service. The customer engagement service sits between a client or company and the client’s or company’s users to help draft messages and to help manage and orchestrate the delivery of messages sent from the client/company to its users.

A “message” could take many different forms and be delivered to a user in many different ways. For example, a “message” could be a mobile or browser-based push notification sent to users by a push notification service.

A message could also be an in-app message that is delivered to a user via a client’s software application. The client’s software application could be resident on a user’s computer, a user’s smartphone or any other device with a processor that is capable of running such a software application. The in-app messages generated and/or delivered by such a software application could be received by the user in various ways.

A message could also be presented to a user via a content card that is embedded within a company’s software application or that is embedded within a company’s website. If a content card is embedded in a company’s software application, the software application itself would obtain content card data sets from a data service for the content cards that are embedded in the software application. The data service may or may not be part of a customer engagement service. The software application would then use the information in obtained data sets to present information, messages, images, sound recordings and possibly video to the user via the content card embedded in the company’s software application.

In the case of content cards that are embedded in a company’s website, a web browser software application would be responsible for presenting the website to the user. When a user navigates to a website that includes one or more embedded content cards, the web browser requests data sets for the embedded content cards from a data service. The web browser then uses information in the obtained data sets to present information, messages, images, sound recordings and possibly video to the user via the embedded content card.

For purposes of the following description and for purposes of the appended claims, a “software application” with embedded content cards will refer to both a traditional software application having embedded content cards, as well as a web browser that is presenting a page of a website that includes embedded content cards. Thus, references to a software application with embedded content cards will encompass a web browser presenting a page of a website with embedded content cards.

Messages could also be presented to a user while the user is using an augmented reality software application. In this instance, the customer engagement service and/or a client company could designate a plurality of message placement locations. The message placement locations would be real geographical locations. When a user operating an augmented reality software application aims a camera of his computing device such that one of the designated message placement locations is within the image being generated by the camera, a message could be displayed at the message placement location. The message displayed at the message placement location could be a static image, an animated image, or a video.

A message also could be a text message (SMS/MMS) that is delivered to users via a smartphone or via a text messaging software application. A message also could be a message delivered to a user via a social media service, or via an Over The Top (OTT) messaging service. A message also could be an email message that is delivered to users via standard email service providers. Moreover, a message could be an audio message delivered to a user via a telephony or VOIP service provider, or a video message delivered via similar means.

For purposes of the following description and the appended claims, any reference to sending a “message” to users is intended to encompass any of the different types of messages and delivery channels mentioned above, as well as any message types and delivery means that are developed in the future.

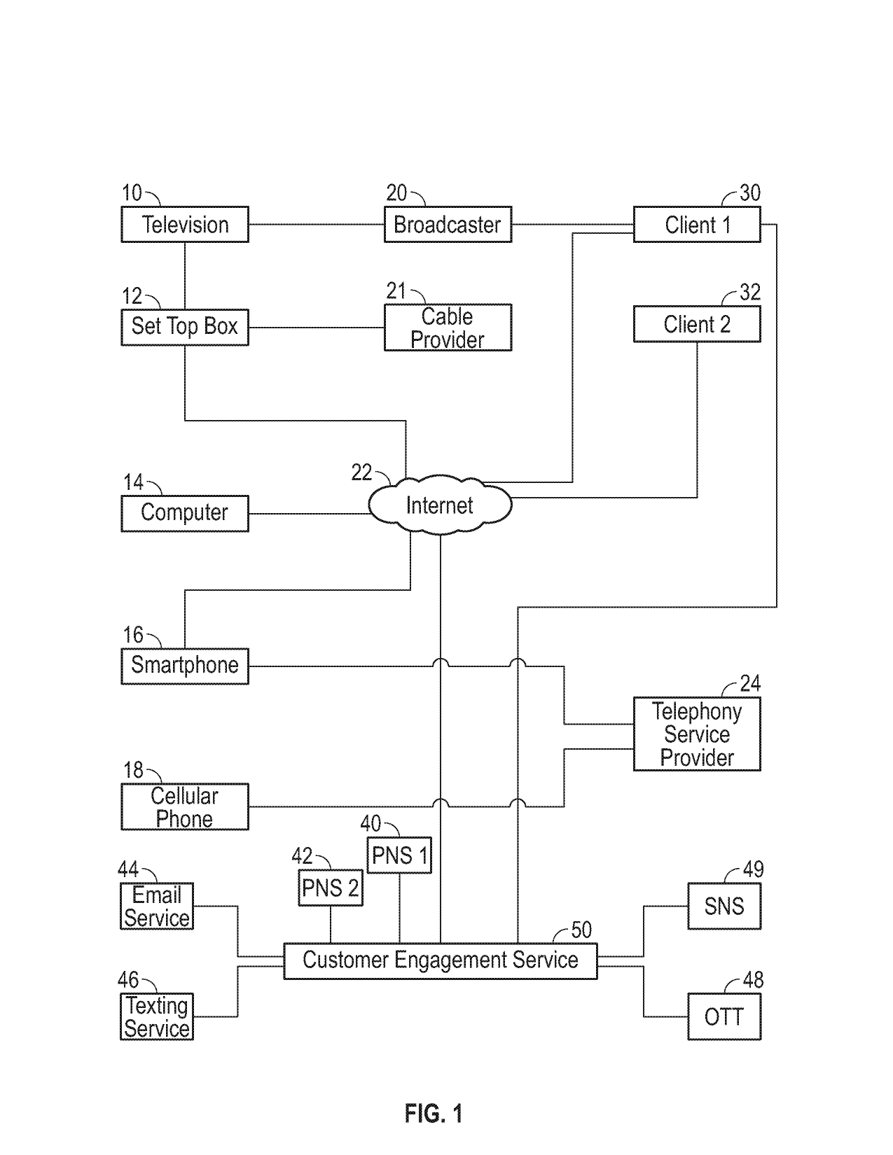

FIG. 1 illustrates a communications environment in which systems and methods embodying the invention could be practiced. As shown in FIG. 1, the communications environment includes client one 30, client two 32 and the customer engagement service 50. Client one 30 and client two 32 are clients of the customer engagement service 50. The clients 30/32 can communicate with the customer engagement service directly, via the Internet 22, or via other means.

Users of the clients 30/32 could utilize the clients’ 30/32 services in various ways. For example, if client one 30 is a media company that provides media content to its users, client one 30 could produce media content that is sent via a broadcaster 20 to a client’s television 10. That media content could be delivered to the user’s television 10 via a set top box 12 that is connected to the user’s television and to the Internet 22 and/or a cable service provider 21. In some instances, a software application on the set top box 12 that is provided by client one 30 could be used to deliver the content to the user’s television 10.

The same or a different user might have a computer 14 that is connected to the Internet 22. The user could utilize a web browser on the computer 14 to access an Internet website provided by client one 30 that also offers media content. Similarly, a software application provided by client one 30 and that is resident on the user’s computer 14 might also be used to access media content provided by client one 30 via the Internet 22.

Yet another user may have a smartphone 16 that is capable of communicating over the Internet 22 and/or via a telephony service provider 24. A software application provided by client one 30 and that is resident on the user’s smartphone 16 could be used to access media content provided by client one 30 via the Internet 22 or via the telephony service provider 24.

The computer 14 and smartphone 16 may be capable of running an augmented reality software application. In that instance, a message could be displayed to a user if the user, operating the augmented reality software application, points a camera of the computer 14 or smartphone 16 such that a designated message placement location is within the image being generated by the camera. The message would be displayed at the designated message placement location.

Still another user might have a cellular telephone 18 that is capable of receiving text messages. This would allow the user of the cellular telephone to receive text messages from client one 30.

FIG. 1 also shows that a first push notification service (PNS) 40 and a second push notification service 42 could be used by the customer engagement service 50 to deliver push notifications to smartphones and/or web browsers. Such messages could be delivered by the push notification services 40/42 to user smartphones via the Internet 22 or via a telephony service provider 24 that provides user smartphone with its native telephony service.

FIG. 1 also shows that an email delivery service 44 could be used by the customer engagement service 50 to send email messages to users. Further, the customer engagement service 50 could use a text messaging service 46 to send text messages to users, or an OTT messaging service 48 to send formatted messages to users. Moreover, the customer engagement service 50 might send a message to users via one or more social networking services 49. Of course, the customer engagement service 50 could utilize any other message delivery service as well to communicate messages to users.

The clients 30/32 in this communications environment could be any sort of client that utilizes a customer engagement service 50 to help them manage engagement with their users. As noted above, a client could be a media broadcaster that produces and sends media content to its users. In other instances, a client could be a retailer whose purchasers are its users. In still other instances, the client could be a service provider, such as a telephony service provider or an Internet service provider. Virtually any business that wishes to send messages to its users could be a client in this environment.

One of skill in the art will appreciate that FIG. 1 only illustrates a very limited number of devices that would be used by users to receive messages from a client, and that could be used to interact with a client. In reality, there would be a very large number of user devices in such a communications environment. Also, a single user could possess and use multiple devices to access a client’s services and to receive messages from a client. Thus, the depiction in FIG. 1 should in no way be considered limiting.

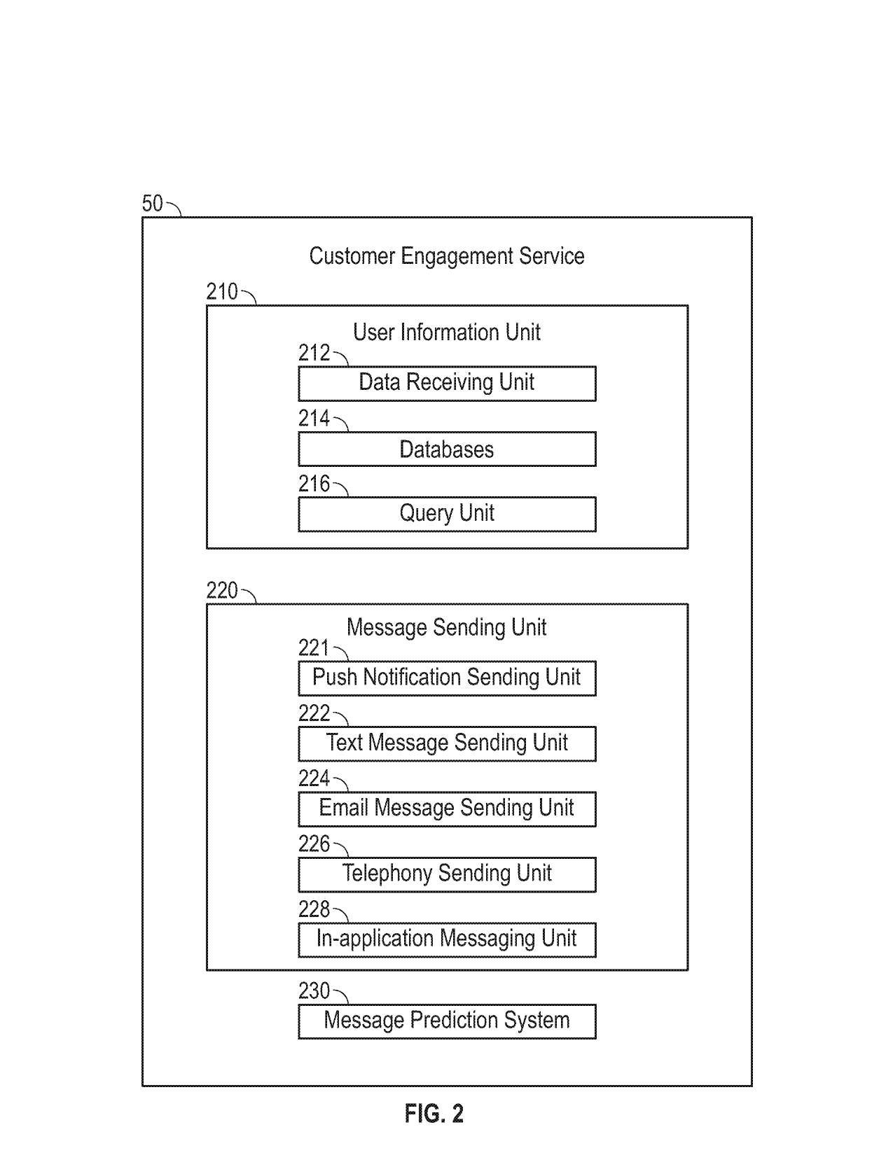

FIG. 2 illustrates selected elements of a customer engagement service 50. The illustration in FIG. 2 is in no way intended to show all elements of a typical customer engagement service 50, and indeed there would typically be many other elements. Likewise, a customer engagement service 50 embodying the invention might not have all the elements illustrated in FIG. 2.

The customer engagement service 50 includes a user information unit 210 that is responsible for receiving and storing information about a client’s users, and that is responsible for responding to requests for that stored information. The user information unit 210 includes a data receiving unit 212 that receives various items of information about users, and that stores that received information in databases 214. The information could be received from various sources. However, typically a client would provide information about its users to the data receiving unit 212 via various means.

For example, in some instances a client may send notifications to the data receiving unit 212 each time that one of the client’s users engages with the client in some fashion. For example, if the client is an online retailer, each time that a user makes a purchase from the online retailer, the online retailer could send the data about the purchase made by that user to the data receiving unit 212. As will be explained below, information received by the data receiving unit 212 may satisfy a trigger for causing an in-application message to be presented to a user.

In another example, if the client is a media broadcaster, and one of the media broadcaster’s users logs onto a website provided by the media broadcaster to access media content, the media broadcaster could send data about that contact to the data receiving unit 212. The data sent could include an identification of the user, the time that the user accessed the website and an indication of what the user accessed or watched while logged into the website. Similarly, any time that a user accesses a client’s website, the client could automatically report that user activity to the data receiving unit 212 of the customer engagement service 50.

In yet another example where the client is a media broadcaster, the media broadcaster could have provided a software application to a user that the user has loaded onto a smartphone or a computing device. The software application could be configured to report the actions that a user takes when using the software application directly to the data receiving unit 212 of a customer engagement service 50. Indeed, in any instance where the client has provided a software application to its users, the software application could be configured to report user activity to the data receiving unit 212 of the customer engagement service 50.

The databases 214 could include one or more journey metadata databases that includes information about how individual users have progressed though defined “journeys”, as discussed above. Thus, when it is necessary to determine what information to insert into a content card that is embedded in a company software application or website, the system may consult the journey metadata database to acquire information about a user’s present position in a journey, to thereby determine what message or messages should now be presented to the user via a content card according to the journey rules/parameters.

Because clients and software applications that the clients provide to their users all report user activity to the customer engagement service 50, the customer engagement service 50 is able to build a detailed picture of each user, the user’s preferences, and the user’s typical courses of action.

In addition, because the customer engagement service 50 is tasked by its client with the delivery of messages to the client’s users, the customer engagement service 50 is also able to build up a record of how and when individual users react to a sent message. This could include an indication of when a user opens a sent message after delivery, and whether and when the user takes an action in response to receipt of a message. For example, because the data receiving unit 212 is also receiving information from the client regarding a user’s contact with the client, the customer engagement service 50 may learn that shortly after an individual user received a message from the client, the user logged into the client’s website, or that shortly after the user received a message, the user opened a software application provided by the client. For all of these reasons, the customer engagement service 50 is able to build detailed user profiles that can be used to predict how individual users will act in certain situations, or how they will respond to certain forms of messaging.

As shown in FIG. 2, the user information unit 210 also includes a query unit 216. The query unit 216 queries the databases 214 to obtain various items of information about the users.

The customer engagement service 50 also includes a message sending unit 220. The message sending unit 220 is responsible for sending messages to a client’s users. As explained above, messages could take many different forms and have many different delivery channels. The message sending unit 220 includes a push notification sending unit 221 that causes mobile or browser-based push notifications to be sent to users via one or more push notification services 40/42, as illustrated in FIG. 1. The push notification sending unit 221 may obtain telephone numbers and push notification service credentials for individual users from the databases 214 with the assistance of the query unit 216. Alternatively, the client may provide that information to the message sending unit 220. The user credential information is then used to cause one or more push notification services 40/42 to deliver a message to the users.

The message sending unit 210 may also include a text message sending unit 222 that causes text-based messages to be sent to users. The text-based messages could be traditional SMS/MMS messages, or messages that are delivered to users via an OTT messaging service or perhaps a social networking service. Information needed to send such text-based messages to users may also be obtained from the databases 214 of the user information unit 210, or that information may be provided by the client. Here again, the message sending unit can enlist the services of one or more text-based message delivery platforms to actually send the message to users.

The message sending unit 220 may also include an email message sending unit 224 that causes email messages to be sent to users. The email message sending unit 224 may obtain email addresses and other information, such as user names, for individual users from the databases 214 with the assistance of the query unit 216, or that information may be provided by the client. The information is then used to send email messages to users. The email messages may be delivered to users by one or more third party email services.

The message sending unit 220 may also include a telephony sending unit 226 that is responsible for delivering audio messages to users via a telephony system. For example, the telephony sending unit 226 could generate an audio recording of a message that is to be delivered to users, or the telephony sending unit 226 could receive such an audio message directly from the client. The telephony sending unit 226 would then obtain information about individual customers from the databases 214 with the assistance of the query unit 216, such as user telephone numbers and user names, or that information could be provided by the client. The telephony sending unit 226 would then enlist the aid of an outside service to deliver the audio message to users via a traditional or VOIP telephony system.

In some instances, the telephony sending unit 226 could generate and operate interactive voice response (IVR) applications to deliver such audio messages to users. Doing so may allow a user to request and receive information or services in addition to the original audio message. If a user does interact with an IVR application, how the user interacts with the IVR application could also be recorded in the databases 214 as additional information about the user.

The message sending unit 220 further includes an in-application messaging unit 228. The in-application messaging unit 228 is responsible for causing messages to be delivered to a user via a client’s software application that it provides to its users. For this reason, the in-application messaging unit 228 can interact with an instantiation of a client’s software application that is resident on a user’s computing device.

The customer engagement service 50 further includes a message prediction system 230, which is discussed in greater detail below. The message prediction system 230 can be used to make a prediction about which of two alternate versions of a message is likely to be more successful with a target audience. Thus, the message prediction system 230 performs a function similar in nature to traditional A/B testing, as discussed above.

“Success” in this context typically means that the message causes members of the target audience to take a particular type of action. Success may also mean that the message caused members of the target audience to refrain from taking a particular type of action. All that said, a message could be deemed “successful” if it causes some other desirable effect. Thus, the meaning of “success” is not to be limited only to causing target audience members to take or not take particular actions. The meaning of “success” could mean other things depending on the message, the context in which the message is sent and the reasons for sending the message.

The message prediction system 230 may also provide a user with the capability to draft and edit potential messages. The message prediction system may be capable of conducting rapid testing of edits to one or more messages in order to provide immediate feedback that is indicative of whether the edits positively or negatively affected the message(s) likelihood of being successful with the target audience. In some cases, this means providing feedback that indicates whether an edited version of a message is more likely or less likely to cause a member of a target audience to take a particular type of action than the original unedited version of the message.

Before discussing details of how the message prediction system 230 analyzes potential messages, it is helpful to first talk about the conventions and terms that will be used in this description to refer to aspects of A/B testing and other complimentary analysis techniques.

When conducting traditional A/B testing, determining which of first and second messages was the most “successful” can vary depending on the circumstances. However, one way that success is often measured is to determine how many or what percentage of the audience members took a particular affirmative action in response to viewing a message. The affirmative action taken by a viewer could be clicking a URL link in the message to navigate to a website. Alternatively, the affirmative action could be making a purchase shortly after viewing the message. Getting even more specific, the affirmative action could be buying a specific product mentioned in the message within a predetermined period of time after viewing a message.

For purposes of this description, we will broadly term taking any sort of affirmative action after viewing a message to be a “conversion.” As mentioned, what constitutes a “conversion” could vary depending on the type, content or purpose of the message. What constitutes a conversion could also vary depending on how the message is communicated to the audience member, as well as on what sort of actions it is possible for an audience member to take in response to viewing a message. All that said and generally speaking, the more conversions a message causes, the more successful the message.

Also, we have been speaking about A/B testing as if it were a comparison between first and second messages. Indeed, much of the A/B testing pits a first version of a message against a second version of the message to see which of the two messages will be most successful. However, “A/B” testing could compare more than two alternate forms of a message. For example, a test could be conducted to determine which of three alternate forms of a message are most successful. Thus, for purposes of this disclosure, “A/B testing” is not limited to comparing only two messages to each other. A/B testing could involve testing more than two messages against one another to determine which of the multiple messages is to be more successful with a target audience.

We will now turn to a broad description of the analysis techniques that are conducted by the message prediction system 230. Thereafter, we will discuss the systems and elements that perform the analysis techniques. We will then disclose some specific methods which can be used to test one or more marketing messages using the disclosed systems and analysis techniques to determine whether they are likely to be successful with a particular target audience. We will also discuss how a potential marketing message can be iteratively edited/modified and tested to help improve the likelihood of success of the message with a target audience.

The disclosed message analysis techniques are designed to provide a prediction about how successful each of two alternate messages will be with a specific target audience. A neural network generates this prediction. The input provided to the neural network is information about the two alternate messages and input about the target audience. The neural network can provide such a prediction in less than a second.

In some embodiments, the prediction is simply a numerical value between 0 and 1 which is indicative of whether the first of the two alternate messages is likely to be more successful with the target audience than the second of the two alternate messages. Thus, a prediction of 0.8 would indicate that the first message is much more likely to be successful with the target audience than the second message. Conversely, a prediction of 0.2 would indicate that the second message is much more likely to be successful with the target audience than the first message. A prediction of 0.5 would indicate that the two alternate messages are equally likely to be successful with the target audience.

Because the neural network analysis techniques are able to rapidly generate a prediction, marketing personnel can quickly draft and test a large number of different versions of a message to quickly determine what message is likely to be most successful with the target audience. For example, a marketer could draft and submit first and second original versions of a message for analysis, and immediately learn that the original first message is likely to be more successful with the target audience than the original second message. Based on that, the marketer could then edit or revise the original second message, perhaps in ways that make it more like the first message and re-submit the original first and edited second message for analysis. Based on the prediction generated for that second pair of messages, the marketer could continue to edit and refine the two alternate messages, pitting one against the other, to further refine and improve the messages.

The ability to quickly obtain results makes it possible to edit and refine messages in a way that is impossible with traditional A/B testing. As mentioned, traditional A/B testing requires detecting and recording the actions that actual audience members take in response to viewing first and second versions of a message. It is often necessary to wait days, weeks or even months before all potential audience members have viewed the first and second messages and had an opportunity to act in response to viewing the first and second messages. In contrast, the new neural network-based analysis techniques can provide near instantaneous feedback.

The inventors have tested a version of a system configured to output a prediction about which of two messages is likely to be more successful with a target audience that generates a prediction in as little as 6 milliseconds. This system can provide a marketer with an editing screen upon which two alternate marketing messages are displayed. The editing screen also displays a prediction value between 0 and 1 indicative of whether the first message is likely to be more successful than the second message with the target audience. Each time the marketer edits one of the messages, the system automatically and immediately re-tests the two messages and updates the prediction value. This makes it possible for the marketer to continuously edit the two messages to refine and improve the messages until the marketer is satisfied with a version of the message.

The input to the neural network that is representative of the messages can be, for each message, a “mean pooled embedding.” Mean pooling is a technique used to aggregate multiple dense vectors into a single vector, where each index in the vector is the mean value of the dense vectors at that index. An open-source search and classification model can be used to generate the mean pooled embeddings for each message. Alternatively, a proprietary model can be used to generate the mean pooled embeddings for each message.

The models used to generate the mean pooled embeddings may only be capable of responding to and representing the text of a message. It may not be possible to represent visual aspects of the messages such as color and font size or included graphical elements. In the future, as additional techniques are developed to generate mean pooled embeddings, it may be possible to also encode things like font size, color and graphical elements and to then take these visual aspects into account in in determining which of two alternate messages are likely to be more successful with a target audience. Thus, the models that generate the mean pooled embeddings for messages may be configured to only respond to and encode plain text. However, future models may also encode visual or graphical aspects that go beyond text.

In some embodiments, the language embedding model can be an autoregressive transformer model trained on a large corpus of text for the purpose of text lookup, similarity measurement, and retrieval-augmented generation (RAG). As such, the model can generate a hidden state (a vector of floating point numbers) per token, where a token is a word or a semantically meaningful part of a word. The hidden states are averaged together to get a single vector representation of a portion of text.

The input to the neural network that is representative of the target audience to which the message(s) will be sent can be generated by an autoencoder that has been trained on end user (audience member) information. An autoencoder is a neural network structure that compresses a large vector space into a smaller vector space and decompresses the smaller vector space back into the original large vector space. The autoencoder makes it possible to compress data in a non-lossy fashion for representational purposes in other models.

In this instance, a user identifies characteristics of the target audience. The autoencoder then encodes a representation of the target audience that is based on the identified characteristics, and the encoded version of the target audience is then submitted to the neural network that generates a prediction about which of two alternate messages is likely to be more successful with the target audience. And because the autoencoder is itself a neural network, this is an instance where a first neural network (the autoencoder) is being used to encode information that is then provided to a second different neural network for analysis purposes.

In some embodiments, a series of filters relating to segments of the target audience are encoded via traditional embeddings, direct input and one hot encoding. The “hidden layer” of the autoencoder is then used to generate a small and dense embedding representative of the target audience.

The mean pooled embeddings for two alternate messages and the encoded representation of the target audience are then provided to a neural network which processes this input and generates a prediction about which of the two alternate messages is likely to be more successful with the target audience.

In some embodiments, the neural network could process the received encoded information through one or more multi-layer perceptrons and then generate a prediction about which of the messages is more likely to be successful. In some embodiment, the prediction can be represented as a value of between 0 and 1 – the value being indicative of the likelihood that the first message will be more successful than the second message with the target audience. In some embodiments, the neural network may be a residual neural network in which the output of multiple layers are added together. This type of structure is often used to allow for many stacked layers to be trained without vanishing gradient.

In order to correctly tune the model used by the neural network, information resulting from many previously performed traditional A/B tests is used as training data. This means the actual alternate messages for many A/B tests, information about the target audiences upon which they were tested, as well as information how “successful” the messages were with the target audiences is used to train the model.

More specifically, the model’s prediction for a test between first and second messages for a particular target audience is compared to the actual result of a real-world A/B test of the two messages on an actual target audience having the same target audience characteristics. The model is then adjusted so that it more accurately predicts the results obtained via real world A/B testing. The resultant model effectively maps the describable relationship between the semantic information of the A/B testing messages, the target audiences, and the certainty that one message outperforms another along typical measures of “success.”

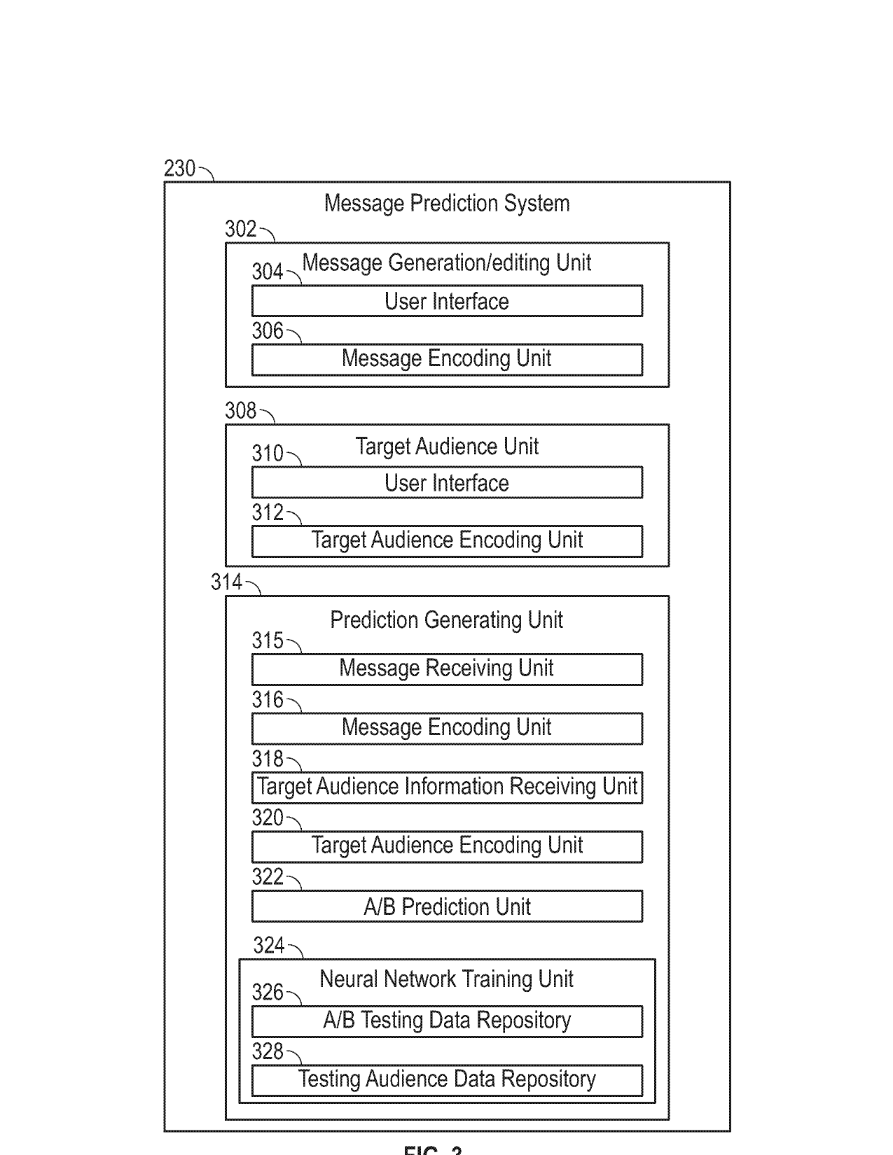

FIG. 3 is a diagram of elements of a message prediction system 230 of a customer engagement service 50 that is capable of conducting the analysis techniques outlined above. While FIG. 3 illustrates one embodiment of a message prediction system 230, other embodiments of a message prediction system 230 could have fewer than all the elements depicted in FIG. 3, or features that are in addition to those depicted in FIG. 3. Thus, the depiction in FIG. 3 should in no way be considered limiting.

The message prediction system includes a message generation/ editing unit 302. The message generation/editing unit 302 includes a user interface 304 which enables a user to draft one or more messages that are to then be tested to determine how successful they are likely to be with a target audience. The user interface 304 could include one or more text editing screens or areas that enable a user to draft a message in each text editing screen or area.

As mentioned above, presently it is not possible to encode graphical or visual aspects of a message. However, to the extent it becomes possible in the future to encode visual or graphical aspects, then the user interface 304 may include the ability for the user to insert or edit graphical elements such as shapes, lines, shading, and other graphical elements.

In view of the fact that the user interface 304 may be used to input first and second alternate versions of a message, the user interface 304 could include a split screen in which each of the two alternate messages are drafted and edited. Typical editing capabilities such as spell check and grammar checking may also be provided.

In some instances, a message which has been created with the user interface 304 of the message generation/editing unit 302 can then be provided directly to the prediction generating unit 314, which is discussed below. In other instances, one or more messages which have been generated via the user interface 304 can be encoded for further analysis using a message encoding unit 306. The message encoding unit 306 could use an open-source search/classification embedding model to generate discrete mean pooled embeddings for a message. As mentioned above, mean pooling is a standard technique used to aggregate multiple dense vectors into a single vector where each index in the vector is the mean value of the dense vectors at that index. Of course, the messages could also be encoded in other ways by other encoding techniques or models.

In some instances, the message encoding unit 306 can use open-source algorithms to create an encoded representation of a message. In other instances, the message encoding unit 306 may be operating via a proprietary algorithm in order to create encoded representations of a message.

The message encoding unit 306 encodes each message into a single embedding (a vector of floating point numbers) via a language embedding model. The language embedding model translates text into distinct tokens via a model-specific tokenizer.

When the message encoding unit 306 of the message generation/ editing unit 302 is used to create an encoded representation of a message, that encoded representation of the message is then provided to the prediction generating unit 314 discussed below for further analysis.

The message prediction system also includes a target audience unit 308. The target audience unit 308 includes a user interface 310 which enables a user to provide information about the target audience against which one or more messages will be tested. Information about a target audience can include characteristics or features of the target audience. Example characteristics could include age, gender, the residential locations of the audience, the income levels of the audience members, as well as a variety of other features, as is well known to those of ordinary skill in this art.

User interface 310 could take on many different forms. In some instances, the user interface 310 could allow a user to simply type in characteristics of a target audience using natural language. In other instances, the user interface could include dropdown menus for various characteristics that allow a user to select certain values for various audience characteristics. In other instances, the user interface 310 could include a graphical interface that allows a user to make selections of various values for various audience characteristics. Regardless, the user interface 310 enable a user to provide information about the target audience against which messages will be tested.

In some embodiments, the information about the target audience which is acquired in the user interface 310 will then be provided to the prediction generating unit 314 discussed below. In other instances, the target audience unit can include a target audience encoding unit 312 which generates an encoded representation of a target audience.

As mentioned above, the target audience encoding unit 312 can include an autoencoder comprising a neural network structure which compresses a large vector space into a smaller vector space, and which also decompresses the smaller representation back into its original shape. The purpose of such a model is to provide a means of compressing data in a non-lossy fashion often for representational purposes in other models. An autoencoder of the target audience encoding unit 312 could be internally trained on end user information or end-user targeting filters that are helpful in representing and encoding the target audience.

In other embodiments, information about a target audience that is acquired via the user interface 310 could be encoded in various other ways before the encoded representation of the target audience is submitted to a neural network for generation of a prediction about whether a first or a second message is likely to be more successful with the target audience.

Regardless of how target audience information is encoded, the encoded representation of the target audience is then provided to the prediction generating unit 314 discussed below.

The message prediction system 230 further includes a prediction generating unit 314 which is responsible for generating a prediction about which of two alternate messages is likely to be most successful with a target audience. The heart of the prediction generating unit 314 is an A/B prediction unit 322 that receives an encoded representation of a first message, an encoded representation of a second message and an encoded representation of a target audience. Using this information, the A/B prediction unit 322 then generates a prediction about which of the first and second messages is likely to be more successful with the target audience.

The A/B prediction unit 322 would typically include a neural network that has been trained on real world A/B testing results. The model used by such a neural network maps the describable relationship between semantic information in the messages, information about target audiences, and the certainty that one message will outperform the other message along typical measures of message success.

In some embodiments, the neural network which is a part of the A/B prediction unit 322 could be a residual neural network, which is one that adds the output of multiple layers such that each layer is effectively additive. The neural network can process the encoded input information through one or more multi-layer perceptrons in order to generate a single output value which represents the likelihood that the first message will be more successful than the second message with the target audience. As mentioned above, that prediction value could be a number between 0 and 1 that is indicative of whether the first message will outperform the second message with the target audience.

In other embodiments the A/B prediction unit 322 could output a prediction about whether a first message is likely to be more successful than a second message with a target audience in other ways. The prediction could be as simple as identifying one of the two alternate messages as likely to be more successful with the target audience. In other instances, the prediction can include information that indicates the degree to which one of the messages is likely to be more successful than the other message.

In some embodiments, the A/B prediction unit could issue two scores, one for each of the two alternate messages. Each score would be indicative of the likelihood that a message will be successful with the target audience. For example, each score could be indicative of the likelihood that a message will cause members of the target audience to take a certain type of action. In this instance, the message with the highest score would be the one most likely to be successful with the target audience.

In the foregoing description, the A/B prediction unit 322 used a neural network to make a prediction about which of two messages is likely to be more successful with a target audience. In alternate embodiments, the A/B prediction unit 322 may not include a neural network. Instead, the A/B prediction unit may use logistical regression or decision trees to arrive at a prediction about which of two messages is more likely to be successful with a target audience.

In instances where a message/generation editing unit 302 receives and encodes first and second messages, the encoded versions of those first and second messages are provided directly to the A/B prediction unit 322 for analysis. Likewise, when a target audience unit 308 receives information about a target audience and creates an encoded version of that information, the encoded representation of the target audience would be provided directly to the A/B prediction unit 322. The A/B prediction unit 322 would then use that encoded information to generate a prediction about whether the first message is likely to be more successful than the second message with the target audience.

However, in other instances the prediction generating unit 314 could directly receive information about first and second messages via a message receiving unit 315. A message encoding unit 316 would then generate encoded representations of the received first and second messages that are passed on to the A/B prediction unit 322 for analysis.

Likewise, in some instances information about a target audience could be provided directly to a target audience information receiving unit 318. The information about the target audience would then be encoded by a target audience encoding unit 320 to create an encoded representation of the target audience. The encoded representation of the target audience created by the target audience encoding unit 320 would then be provided to the A/B prediction unit 322 for analysis.

The prediction generating unit 314 can also include a neural network training unit 324 that is used to train the model being used by the A/B prediction unit 322. The neural network training unit can include an A/B testing data repository 326 that includes information about real world A/B testing that has previously been conducted for first and second messages against various target audiences. The neural network training unit 324 may also include a separate target audience data repository 328 that includes information about various different target audiences, or the characteristics that go into defining or identifying a target audience.

Training of the model being used by the A/B prediction unit 322 is accomplished by submitting encoded representations of actual first and second messages that were previously A/B tested against an actual target audience. Information about that target audience would also be provided to the A/B prediction unit 322. The A/B prediction unit 322 would then generate a prediction about how likely it is that the first of the first of the two messages would be more successful than the second message with the target audience. That prediction generated by the A/B prediction unit 322 is then compared to the actual results of the real-world A/B testing of those two messages against the target audience. To the extent the prediction generated by the A/B prediction unit 322 differs from the actual real-world testing results, the model is adjusted to take that difference into account. This typically involves adjusting the model such that the prediction generated by the A/B prediction unit 322 more closely matches the results of the real-world testing. The process of testing and making adjustments to the model can be iteratively performed until the A/B prediction unit 322 reliably provides predictions which generally match the results of real-world A/B testing.

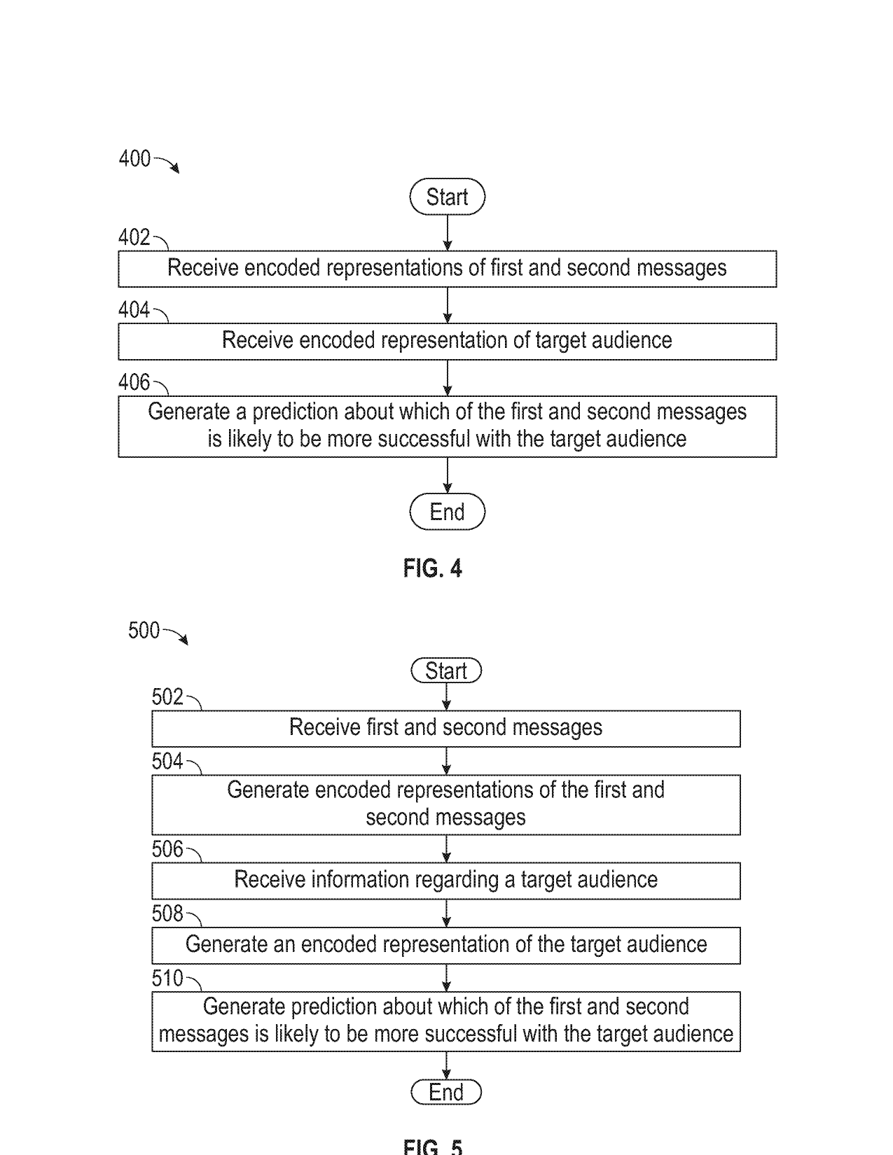

FIG. 4 illustrates the steps of a first generalized method 400 of providing a prediction about which of first and second messages is likely to be the most successful with a target audience. The method begins and proceeds to step 402 where an A/B prediction unit 322 receives encoded representations of first and second messages. Those encoded representations of first and second messages could have been previously generated by a message generation/editing unit 302 of a message prediction system 230.

The method then proceeds to step 404 where the A/B prediction unit 322 receives an encoded representation of a target audience. Here again, the encoded representation of a target audience could have been previously generated via a target audience unit 308 of a message prediction system 230.

The method then proceeds to step 406 where the A/B prediction unit 322 generates a prediction about which of the first and second messages is likely to be more successful with the target audience. As mentioned previously, the prediction could be in the form of a value between 0 and 1 that indicates the degree to which the first message is likely to be more successful with the target audience than the second message. The method then ends.

FIG. 5 illustrates the steps of a second method 500 of generating a prediction of about which of first and second messages is likely to be more successful with a target audience. In this method, first and second messages and information about a target audience are received and processed, as opposed to receiving coded versions of first and second messages and an encoded representation of a target audience, as occurred in the method depicted in FIG. 4.

The method begins and proceeds to step 502 in which a user interface 304 of a message generation/editing unit 302 receives information about first and second messages. This step can involve receiving previously generated first and second messages. Alternatively, this step could include a user directly inputting and editing the first and second messages until the user is satisfied with those messages. The method then proceeds to step 504 where a message encoding unit 306 generates an encoded representation of the first and second messages.

The method then proceeds to step 506 where a user interface 310 of a target audience unit 308 receives information about a target audience. In step 508 a target audience encoding unit 312 generates an encoded representation of the target audience using the information received in step 506.

The method then proceeds to step 510 where an A/B prediction unit 322 generates a prediction about which of the first and second messages is likely to be more successful with the target audience. The method then ends.

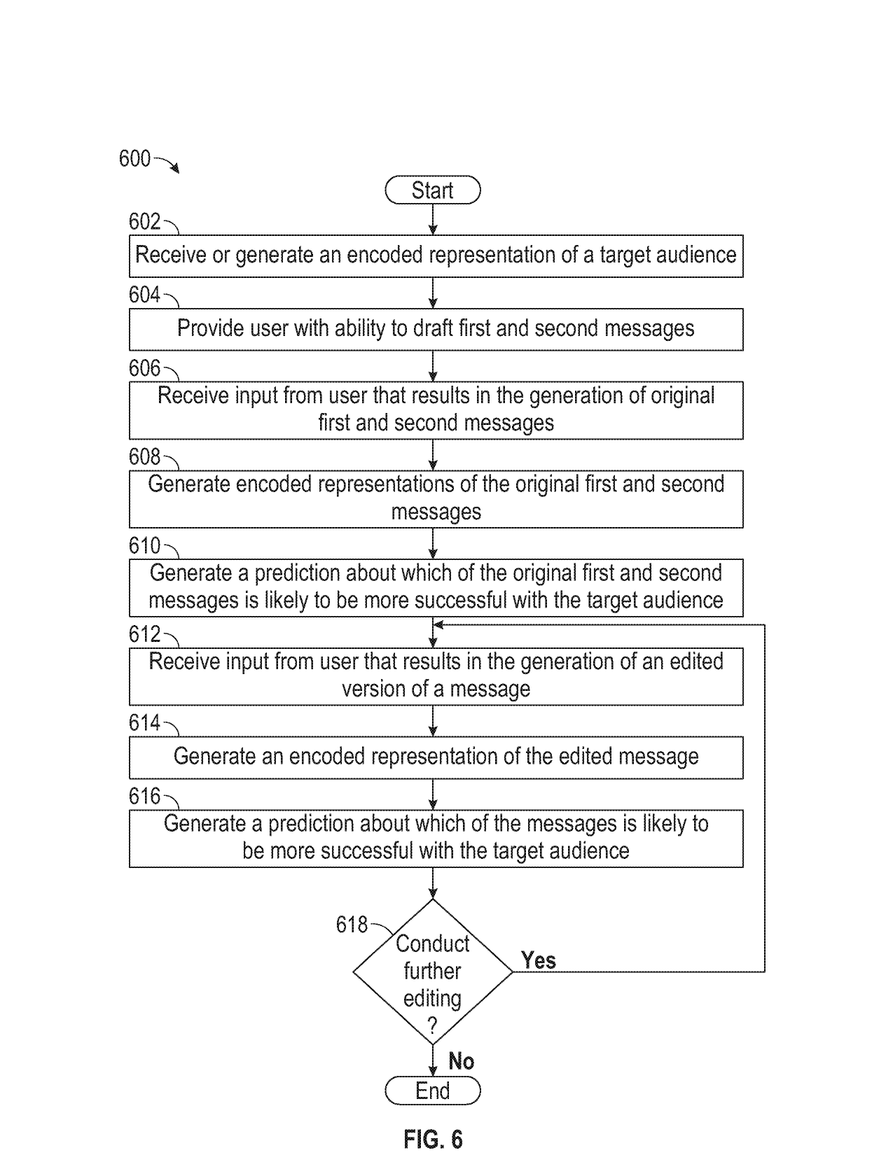

FIG. 6 illustrates steps of a method which can be used to create, edit and iteratively test first and second messages in order to develop a message that has a high probability of being successful with a target audience.

The method begins and proceeds to step 602 in which information about a target audience is received, or an encoded representation of a target audience is received. In some instances, step 602 could involve an A/B prediction unit 322 of a prediction generating unit 314 receiving an encoded representation of a target audience. In other instances, step 602 could include receiving information about a target audience via user interface 310 of target audience unit 308, and then generating an encoded representation of the target audience with a target audience encoding unit 312.

The method then proceeds to step 604, which involves providing the user with the ability to draft first and second messages. As mentioned above, this could include providing a user interface 304 that allows a user to input and edit first and second messages. This would typically include providing an input screen with locations that can be used to input and edit first and second messages. The user interface 304 typically would also include an area to display a prediction value that indicates whether the first message is likely to be more successful than the second message with the target audience. In step 606, input is received from a user via the user interface 304, and that input is used to create original first and second messages.

The method then proceeds to step 608 in which a message encoding unit 306 generates encoded representations of the original first and second messages. Those encoded representations of the original first and second messages are then provided to an A/B prediction unit 322.

In step 610, an A/B prediction unit 322 generates a prediction about which of the original first and second messages is likely to be most successful with the target audience. That prediction is then sent to or displayed to the user via the user interface 304 that was used to create the original first and second messages.

The method then proceeds to step 612 where additional input is received from the user, via the user interface 304, and the received input is used to generate an edited version of one or both of the first and second messages being displayed in the user interface 304. For example, the user could edit the first message displayed in the user interface 304 in an attempt to increase the likelihood that the first message will be successful with the target audience.

The method then proceeds to step 614 where the message encoding unit 306 generates an encoded representation of the edited message(s). That encoded representation of the edited message(s) is then provided to the A/B prediction unit 322.

In step 616, the A/B prediction unit generates a prediction about whether the first message now being displayed in the user interface 304 is likely to be the most successful than the second message now being displayed in the user interface 304 with the target audience. That prediction is then presented to the user via the user interface 304. Note, at least one of the messages now being displayed in the user interface 304 would be an edited version of a previously tested message. Presumably, the prediction generated in step 616 will be different from the prediction generated in step 610. This allows a user to see how the edits made to the original message(s) affect the outcome of the prediction.

In step 618 a check is performed to determine if the user wishes to make further edits to either of the first and second messages now being displayed in the user interface 304. If so, the method loops back to step 612 and further input is received from the user to edit one or both of the messages now being displayed in the user interface 304. Steps 612 to 616 can be repeatedly performed so that a user can iteratively edit and test various different versions of messages to help refine the message to increase the likelihood that the messages will be successful with a target audience.

Note, the check performed in step 618 could simply be a check to determine if the user has begun editing one of the messages. If so, the method proceeds back to step 612 to receive edits to one or more of the messages. Once the user stops editing the message(s), the edited message(s) is encoded in step 614 and the A/B prediction unit 322 generates a new prediction in step 616 about whether the first message now being displayed in the user interface 304 is likely to be more successful than the second message now being displayed in the user interface 304. The prediction is then presented to the user in the user interface 304. When the user is finally done making edits, the method ends.

The systems and methods described herein allow marketing personnel to receive predictions about how a proposed marketing message is likely to succeed against a target audience without conducting traditional A/B testing against actual members of the target audience. The predictions can be received almost instantly, which is far superior to real-world testing which requires days and sometimes weeks and months to accomplish. Also, the predictions generated by the disclosed systems and methods can be obtained for a much lower cost than predictions obtained via real-world A/B testing.

In addition, reliable predictions about how successful a message is likely to be with a target audience can be generated by the disclosed systems and methods even when the target audience is quite small, which is something that is difficult to accomplish with real-world A/B testing.

Moreover, the systems and methods disclosed herein provide marketing personnel with a completely new tool that makes it possible to edit and re-test marketing messages against a target audience in an extremely short period of time. Because of the long periods of time needed to accomplish real-world A/B testing, it was impossible to iteratively edit and test multiple different versions of marketing messages in a span of time that made the results worthwhile and useful. Thus, the disclosed systems and methods provide marketing personnel with an entirely new tool having great utility, one which allows marketing personnel to hone a marketing message for a particular purpose with a specific target audience.

In some instances, marketing personnel may use the disclosed systems and methods to develop two or a few messages that they believe will be successful with a target audience. Those messages could then be A/B tested in the real world to confirm that they are likely to be successful. The use of the disclosed systems and methods would make it possible to ensure that the messages tested in real-world testing have a high likelihood of being successful before relatively expensive real-world testing is conducted.

Also, the prediction about which of two messages is more likely to be successful with a target audience can be used to inform or describe a prior probability distribution which, when applied to an A/B test, can enable marketers to more rapidly or more accurately resolve an A/B test.

The present invention may be embodied in methods, apparatus, electronic devices, and/or computer program products. Accordingly, the invention may be embodied in hardware and/or in software (including firmware, resident software, micro-code, and the like), which may be generally referred to herein as a “circuit” or “module.” Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device. These computer program instructions may also be stored in a computer-usable or computer-readable memory that may direct a computer or other programmable data processing apparatus to function in a particular manner, such that the instructions stored in the computer-usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, infrared, or semiconductor system, apparatus or device. More specific examples (a non-exhaustive list) of the computer-readable medium include the following: hard disks, optical storage devices, magnetic storage devices, an electrical connection having one or more wires, a portable computer diskette, a random access memory (RAM), a read-only memory (ROM), an erasable programmable read-only memory (EPROM or Flash memory), an optical fiber, and a compact disc read-only memory (CD-ROM).

Computer program code for carrying out operations of the present invention may be written in an object-oriented programming language, such as Java®, Smalltalk or C++, and the like. However, the computer program code for carrying out operations of the present invention may also be written in conventional procedural programming languages, such as the “C” programming language and/or any other lower-level assembler languages. It will be further appreciated that the functionality of any or all of the program modules may also be implemented using discrete hardware components, one or more Application Specific Integrated Circuits (ASICs), or programmed Digital Signal Processors or microcontrollers.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the present disclosure and its practical applications, to thereby enable others skilled in the art to best utilize the invention and various embodiments with various modifications as may be suited to the particular use contemplated.

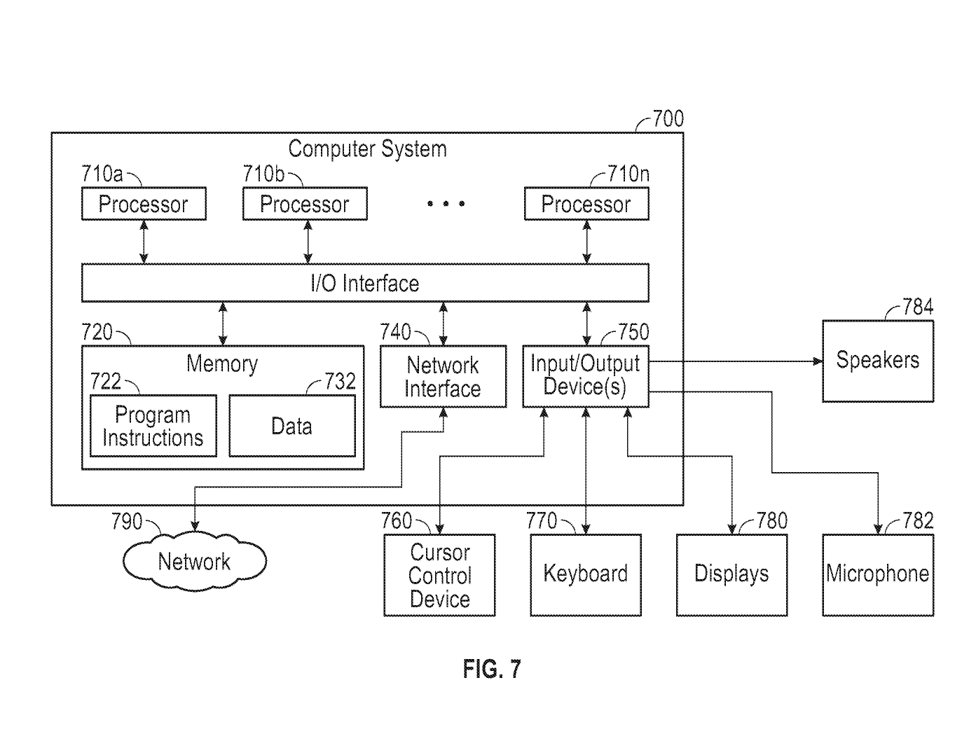

FIG. 7 depicts a computer system 700 that can be utilized in various embodiments of the present invention to implement the invention according to one or more embodiments. The various embodiments as described herein may be executed on one or more computer systems, which may interact with various other devices. One such computer system is the computer system 700 illustrated in FIG. 7. The computer system 700 may be configured to implement the methods described above. The computer system 700 may be used to implement any other system, device, element, functionality or method of the above-described embodiments. In the illustrated embodiments, the computer system 700 may be configured to implement the disclosed methods as processor-executable executable program instructions 722 (e.g., program instructions executable by processor(s) 710) in various embodiments.

In the illustrated embodiment, computer system 700 includes one or more processors 710a-710n coupled to a system memory 720 via an input/output (I/O) interface 730. Computer system 700 further includes a network interface 740 coupled to I/O interface 730, and one or more input/output devices 750, such as cursor control device 760, keyboard 770, display(s) 780, microphone 782 and speakers 784. In various embodiments, any of the components may be utilized by the system to receive user input described above. In various embodiments, a user interface may be generated and displayed on display 780. In some cases, it is contemplated that embodiments may be implemented using a single instance of computer system 700, while in other embodiments multiple such systems, or multiple nodes making up computer system 700, may be configured to host different portions or instances of various embodiments. For example, in one embodiment some elements may be implemented via one or more nodes of computer system 700 that are distinct from those nodes implementing other elements. In another example, multiple nodes may implement computer system 700 in a distributed manner.

In different embodiments, the computer system 700 may be any of various types of devices, including, but not limited to, a personal computer system, desktop computer, laptop, notebook, or netbook computer, a portable computing device, a mainframe computer system, handheld computer, workstation, network computer, a smartphone, a camera, a set top box, a mobile device, a consumer device, video game console, handheld video game device, application server, storage device, a peripheral device such as a switch, modem, router, or in general any type of computing or electronic device.

In various embodiments, the computer system 700 may be a uniprocessor system including one processor 710, or a multiprocessor system including several processors 710 (e.g., two, four, eight, or another suitable number). Processors 710 may be any suitable processor capable of executing instructions. For example, in various embodiments processors 710 may be general-purpose or embedded processors implementing any of a variety of instruction set architectures (ISAs). In multiprocessor systems, each of processors 710 may commonly, but not necessarily, implement the same ISA.

System memory 720 may be configured to store program instructions 722 and/or data 732 accessible by processor 710. In various embodiments, system memory 720 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 720. In other embodiments, program instructions and/or data may be received, sent or stored upon different types of computer-accessible media or on similar media separate from system memory 720 or computer system 700.

In one embodiment, I/O interface 730 may be configured to coordinate I/O traffic between processor 710, system memory 720, and any peripheral devices in the device, including network interface 740 or other peripheral interfaces, such as input/output devices 750. In some embodiments, I/O interface 730 may perform any necessary protocol, timing or other data transformations to convert data signals from one component (e.g., system memory 720) into a format suitable for use by another component (e.g., processor 710). In some embodiments, I/O interface 730 may include support for devices attached through various types of peripheral buses, such as a variant of the Peripheral Component Interconnect (PCI) bus standard or the Universal Serial Bus (USB) standard, for example. In some embodiments, the function of I/O interface 730 may be split into two or more separate components, such as a north bridge and a south bridge, for example. Also, in some embodiments some or all of the functionality of I/O interface 730, such as an interface to system memory 720, may be incorporated directly into processor 710.

Network interface 740 may be configured to allow data to be exchanged between computer system 700 and other devices attached to a network (e.g., network 790), such as one or more external systems or between nodes of computer system 700. In various embodiments, network 790 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 740 may support communication via wired or wireless general data networks, such as any suitable type of Ethernet network; for example, via telecommunications/telephony networks such as analog voice networks or digital fiber communications networks, via storage area networks such as Fiber Channel SANs, or via any other suitable type of network and/or protocol.

Input/output devices 750 may, in some embodiments, include one or more display terminals, keyboards, keypads, touchpads, scanning devices, voice or optical recognition devices, or any other devices suitable for entering or accessing data by one or more computer systems 700. Multiple input/output devices 750 may be present in computer system 700 or may be distributed on various nodes of computer system 700. In some embodiments, similar input/output devices may be separate from computer system 700 and may interact with one or more nodes of computer system 700 through a wired or wireless connection, such as over network interface 740.

In some embodiments, the illustrated computer system may implement any of the operations and methods described above, such as the methods illustrated by the flowcharts of FIGS. 4-6. In other embodiments, different elements and data may be included.

Those skilled in the art will appreciate that the computer system 700 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 700 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 700 may be transmitted to computer system 700 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

What is claimed is:

1. A method of assisting a user in editing messages that are to be sent to individuals who are members of a target audience, comprising:
receiving, from the user, information about a target audience;
generating an encoded representation of the target audience based on the received information about the target audience;
obtaining input from the user that results in the user drafting original first and second messages that are both intended to cause members of the target audience to take a specific action;
generating encoded representations of the original first and second messages;
generating a first prediction about which of the original first and second messages is more likely to be successful in causing members of the target audience to take the specific action, wherein the first prediction is based on the encoded representations of the original first and second messages and the encoded representation of the target audience; and
displaying the first prediction to the user.

2. The method of claim 1, further comprising:
obtaining input from the user that that results in the user creating an edited version of the original first message;
generating an encoded representation of the edited version of the original first message;
generating a second prediction about which of the original second message and the edited version of the original first message is more likely to be successful in causing members of the target audience to take the specific action, wherein the second prediction is based on the encoded representations of the edited version of the original first, the encoded representation of the original second message and the encoded representation of the target audience; and
displaying the second prediction to the user.

3. The method of claim 2, further comprising:
obtaining from the user input that that results in the user creating an edited version of the original second message;
generating an encoded representation of the edited version of the original second message;
generating a third prediction about which of the edited version of the original first message and the edited version of the original second message is more likely to be successful in causing members of the target audience to take the specific action, wherein the third prediction is based on the encoded representations of the edited version of the original first, the encoded representation of the edited version of the original second message and the encoded representation of the target audience; and
displaying the third prediction to the user.

4. The method of claim 1, wherein receiving information about the target audience from the user comprises:
presenting to the user a plurality of selectable items that are each indicative of a different characteristic of a target audience; and
receiving input from the user that indicates which of the presented items the user has selected.

5. The method of claim 1, wherein generating a first prediction comprises generating the first prediction with a neural network.

6. The method of claim 5, wherein generating an encoded representation of the original first message comprises generating a first mean pooled embedding based on the original first message, and wherein generating an encoded representation of the original second message comprises generating a second mean pooled embedding based on the original second message.

7. The method of claim 5, wherein the encoded representation of the target audience is generated with an autoencoder that comprises a neural network structure configured to encode a large vector space into a smaller vector space.

8. The method of claim 5, wherein the neural network is a multi-layer residual neural network.

9. The method of claim 8, wherein the multi-layer residual neural network generates the first prediction by processing the received encoded representations of the original first and second messages and the received encoded representation of the target audience through one or more multi-layer perceptrons and generating the prediction.

10. The method of claim 9, wherein generating the prediction comprises projecting to a single output space a scaled value that is indicative of the prediction.

11. The method of claim 5, wherein the neural network uses a model that maps a relationship between the semantic information in messages and characteristics of target audiences to a probability a message will be successful with a target audience.

12. The method of claim 11, wherein the model used by the neural network is trained using the results of real world A/B testing of actual messages on actual target audiences.

13. The method of claim 1, wherein the first prediction is generated by a prediction generating unit that uses a model that maps a relationship between the semantic information in messages and characteristics of target audiences to a probability a message will cause a member of a target audience to take particular types of actions.

14. The method of claim 13, wherein the model used by the neural network is trained using the results of real world A/B testing of actual messages on actual target audiences.

15. A system that assists a user in editing messages that are to be sent to individuals who are members of a target audience, comprising:
a memory; and
one or more processors that are configured to perform a method comprising:
receiving, from the user, information about a target audience;
generating an encoded representation of the target audience based on the received information about the target audience;
obtaining input from the user that results in the user drafting original first and second messages that are both intended to cause members of the target audience to take a specific action;
generating encoded representations of the original first and second messages;
generating a first prediction about which of the original first and second messages is more likely to be successful in causing members of the target audience to take the specific action, wherein the first prediction is based on the encoded representations of the original first and second messages and the encoded representation of the target audience; and
displaying the first prediction to the user.

16. The system of claim 15, wherein the method performed by the one or more processors further comprises:
obtaining input from the user that that results in the user creating an edited version of the original first message;
generating an encoded representation of the edited version of the original first message;
generating a second prediction about which of the original second message and the edited version of the original first message is more likely to be successful in causing members of the target audience to take the specific action, wherein the second prediction is based on the encoded representations of the edited version of the original first, the encoded representation of the original second message and the encoded representation of the target audience; and
displaying the second prediction to the user.

17. The system of claim 16, wherein the method performed by the one or more processors further comprises:
obtaining from the user input that that results in the user creating an edited version of the original second message;
generating an encoded representation of the edited version of the original second message;
generating a third prediction about which of the edited version of the original first message and the edited version of the original second message is more likely to be successful in causing members of the target audience to take the specific action, wherein the third prediction is based on the encoded representations of the edited version of the original first, the encoded representation of the edited version of the original second message and the encoded representation of the target audience; and
displaying the third prediction to the user.

18. The system of claim 15, wherein generating an encoded representation of the original first message comprises generating a first mean pooled embedding based on the original first message, and wherein generating an encoded representation of the original second message comprises generating a second mean pooled embedding based on the original second message.

19. The system of claim 18, wherein the encoded representation of the target audience is generated with an autoencoder that comprises a neural network structure configured to encode a large vector space into a smaller vector space.

20. The system of claim 15, wherein the first prediction is generated by a prediction generating unit that uses a model that maps a relationship between the semantic information in messages and characteristics of target audiences to a probability a message will cause a member of a target audience to take particular types of actions.
